(19) United States
(12) Patent Application Publication
(10) Pub. No.: US 2026/0133724 A1
(43) Pub. Date: May 14, 2026

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: KAZUYUKI SAITO, Kanagawa (JP)

(21) Appl. No.: 19/318,171

(22) Filed: Sep. 3, 2025

(30) Foreign Application Priority Data
Sep. 9, 2024 (JP) 2024-155158

(51) Int. Cl. G06F 3/12

(52) U.S. Cl. CPC G06F 3/1206; G06F 3/1228; G06F 3/1253

(57) ABSTRACT

A non-transitory computer-readable storage medium storing an application program including executable instructions, which when executed by one or more processors of an information processing apparatus including an Internet Printing Protocol (IPP) Class Driver and the application program cooperating with the IPP Class Driver, cause the information processing apparatus to perform a control method including receiving, from a user, a selection of a data format to be output to a printing apparatus without data format conversion, and performing control such that, in receiving from the user a specification of a setting value for printing data in the selected data format, a specification of a setting value that is inexecutable in a case of performing the process is not accepted.

### BACKGROUND

### Field of the Technology

The present disclosure relates to an information processing apparatus, a control method for an information processing apparatus, and a storage medium.

### Description of the Related Art

In recent years, there has been consideration of general-purpose printer drivers (local printer drivers) that directly communicate with image forming apparatuses, using an industry standard protocol, such as Internet Printing Protocol (IPP).

A local printer driver is provided by a provider (supplier) of an operating system (OS) of a client terminal, and generates print data that can be interpreted by printers made by a plurality of printer manufacturers (vendors). A local printer driver can communicate with printers manufactured by a plurality of printer manufacturers (vendors). Thus, by using a local printer driver, a user can transmit a print job to an image forming apparatus without installation of a vendor-specific printer driver.

Printing using a cloud print service has been considered. In a cloud print service, a printer driver for the cloud print service (cloud printer driver) is installed in an information processing apparatus. The cloud printer driver is also a driver provided by a provider (supplier) of an OS of a client terminal, and generates print data that can be interpreted by printers from a plurality of printer vendors.

In a cloud print service, an information processing apparatus uses a cloud printer driver to transmit a print job to the cloud print service, the cloud print service transmits the print job to an image forming apparatus, and printing is performed.

The above-described local printer driver and cloud printer driver process print jobs to be printed by image forming apparatuses from various vendors, so that there are limitations on the items and functions that can be configured as print settings. Thus, it has been considered to extend print settings in association with the printer driver, using the identification information for a printer linked to the printer driver. This enables implementation of a vendor-specific print setting user interface (UI) and print job editing function.

An application that extends such print settings (print setting extension application) receives, from the OS, intermediate image data for editing that is expressed in an Extensible Markup Language (XML) format, such as XML Paper Specification (XPS), and after editing, converts the data into Page Description Language (PDL) data for printing.

The OS provides a PDL-conversion application programming interface (API) for converting intermediate image data into PDL data. The printer driver and the print setting extension application use the API to convert intermediate image data into PDL data.

There has been conventionally a mechanism called pass-through printing in which print data (PDL such as Post Script or PDF) created by a dedicated document generation application is transmitted directly to a printer, skipping PDL conversion in a printer driver.

Pass-through printing is used to prevent the conversion of contents such as vector text, lines, fonts, page layouts, and colors that have already been set in dedicated document generation applications for creating high-quality printed materials in publishing, design, and other industries.

Japanese Patent Laid-Open No. 2021-108001 describes an extension application that enables printing reflecting extended functions.

In IPP printing as well, there is a method in which conversion of print data generated by a document generation application into intermediate image formats such as XPS or into a PDL is skipped.

However, in pass-through printing using IPP, the PDLs supported for pass-through printing differs from printer to printer. Therefore, in such a configuration as discussed in Japanese Patent Laid-Open No. 2021-108001, if the user does not recognize the data formats that can be used for pass-through printing, the printer may receive unexpected data and fail to print.

### SUMMARY

Embodiments of the present disclosure provide a non-transitory computer-readable storage medium storing an application program including executable instructions, which when executed by one or more processors of an information processing apparatus including an Internet Printing Protocol (IPP) Class Driver and the application program cooperating with the IPP Class Driver, cause the information processing apparatus to perform a control method including receiving, from a user, a selection of a data format to be output to a printing apparatus without data format conversion, and performing control such that, in receiving from the user a specification of a setting value for printing data in the selected data format, a specification of a setting value that is inexecutable in a case of performing the process is not accepted.

Features of the present disclosure will become apparent from the following description of embodiments with reference to the attached drawings. The following description of embodiments is described by way of example.

### BRIEF DESCRIPTION OF THE DRAWINGS

FIG. 1 is a system configuration diagram.

FIGS. 2A to 2E are hardware configuration diagrams.

FIGS. 3A and 3B are a diagram illustrating an example of a sequence related to option setting in a first embodiment.

FIGS. 4A and 4B are a diagram illustrating an example of a sequence related to a process from print setting to print job transmission according to the first embodiment.

FIGS. 5A to 5D are diagrams illustrating examples of an option setting user interface (UI).

FIGS. 6A to 6D are diagrams illustrating examples of a pass-through printing ON/OFF determination process.

FIGS. 7A to 7D are diagrams illustrating examples of a print setting UI.

FIGS. 8A and 8B are diagrams illustrating examples of pass-through printing availability determination.

FIGS. 9A and 9B are diagrams illustrating examples of a warning and option display process.

### DESCRIPTION OF THE EMBODIMENTS

Hereinafter, embodiments of the present disclosure will be described with reference to the accompanying drawings.

### First Embodiment

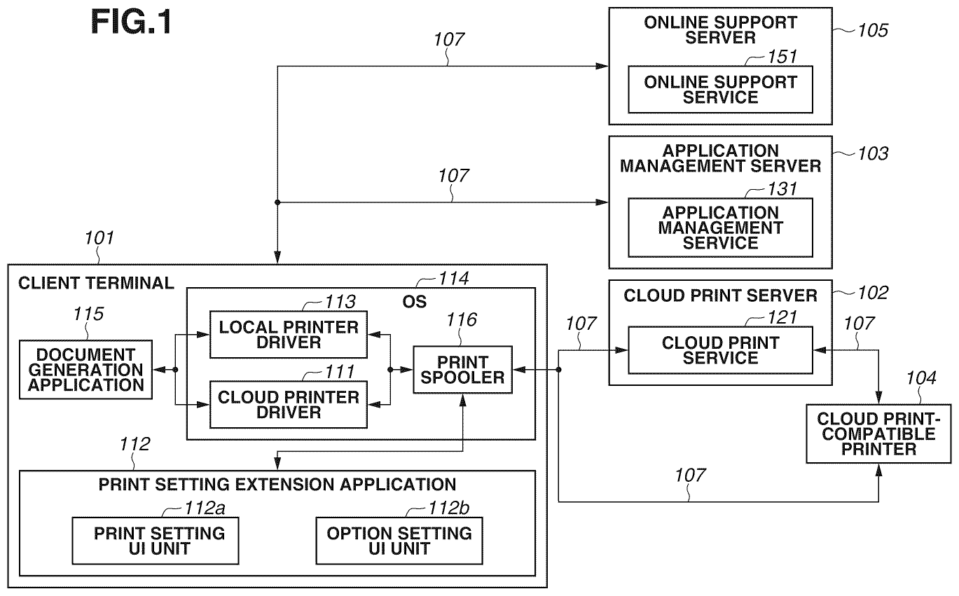

FIG. 1 illustrates a configuration of a printing system for cloud printing in a first embodiment. A client terminal 101, a cloud print server 102, an application management server 103, a cloud print-compatible printer 104, and an online support server 105 are connected via a network 107.

Although FIG. 1 illustrates one client terminal 101 and one cloud print-compatible printer 104, there may be provided a plurality of client terminals 101 and a plurality of cloud print-compatible printers 104.

The cloud print server 102, the application management server 103, and the online support server 105 may be each a server system that includes a plurality of information processing apparatuses. Configuring each server as a server system including a plurality of information processing apparatuses enables distribution of processing load across the plurality of information processing apparatuses.

The cloud print server 102, the application management server 103, and the online support server 105 may be virtually configured within one physical information processing apparatus.

The network 107 is assumed to be a wide area network (WAN), such as the Internet, for connection to cloud services, but may be configured to operate in a closed environment, such as an in-house local area network (LAN).

The client terminal 101 is an information processing apparatus such as a personal computer (PC), a tablet, or a smartphone, and is a terminal that is directly operated by a user. Any application software can be executed on the client terminal 101.

A document generation application 115 is an application that can display and create images, documents, and other data to be printed. The document generation application 115 may include various applications for word processing, spreadsheets, web browsing, and painting, for example.

A local printer driver 113 and a cloud printer driver 111 are software provided by the provider (supplier) of an operating system (OS) 114 of the client terminal, and generate print data that can be interpreted by printers made by a plurality of different printer manufacturers (vendors). The local printer driver 113 and the cloud printer driver 111 can output (transmit) such print data to the plurality of printers made by the plurality of different printer manufacturers.

An example of each of the local printer driver 113 and the cloud printer driver 111 is the Internet Printing Protocol (IPP) class driver for Microsoft Windows Operating System (Windows®). Software and modules for printing included in the OS 114, such as the cloud printer driver 111, the local printer driver 113, and a print spooler 116, may be collectively referred to as “printing software”.

A print setting extension application 112 is an application program provided by one of the above-described printer manufacturers, which provides the printer used for printing. Since the print setting extension application 112 supports printing using the local printer driver 113 and the cloud printer driver 111, the print setting extension application 112 is sometimes called a print support application (PSA).

The print setting extension application 112 can also extend functions related to print settings of the local printer driver 113 and the cloud printer driver 111 via the print spooler 116 of the OS 114.

The cloud print-compatible printer 104 is a device that actually prints on recording media, such as sheets, and is an image forming apparatus that converts print data received via the network 107 into image data and prints the image data.

A print setting user interface (UI) unit 112a is a print setting UI extended by a printer vendor in the print setting extension application 112, and provides the user with the print setting UI in place of a UI provided by the cloud printer driver 111.

The print setting UI unit 112a generates a print setting UI based on capability information acquired by the OS 114 and the print setting extension application 112 from the cloud print-compatible printer 104 and the cloud print service 121.

In the print setting extension application 112, the print setting UI unit 112a performs processes such as collecting device capability information from the print spooler 116 and the cloud print-compatible printer 104, editing and storing configuration information objects, and passing configuration information objects to the OS 114. The configuration information objects refer to a collection of data groups to be used to edit device capability information.

The cloud print-compatible printer 104 can receive print data from the client terminal 101 via the cloud print server 102. Alternatively, the cloud print-compatible printer 104 can receive print data directly from the client terminal 101 without passing through the cloud print server 102.

The cloud print-compatible printer 104 receives print data generated by the cloud printer driver 111 of the client terminal 101 via the cloud print server 102. The cloud print-compatible printer 104 receives print data generated by the local printer driver 113 of the client terminal 101 without passing through the cloud print server 102.

The cloud print server 102 receives a print instruction and print data from an external device. The cloud print server 102 then transmits the received print data to a predetermined cloud print-compatible printer 104.

The application management server 103 stores and manages various applications. The application management server 103 receives application identification information and a download request from the client terminal 101, and transmits to the client terminal 101 an application identified based on the received identification information.

The online support server 105 is a server apparatus that provides an online support service 151. The online support server 105 is a server apparatus that provides the client terminal 101 with a file including information for extending the functions of the client terminal 101.

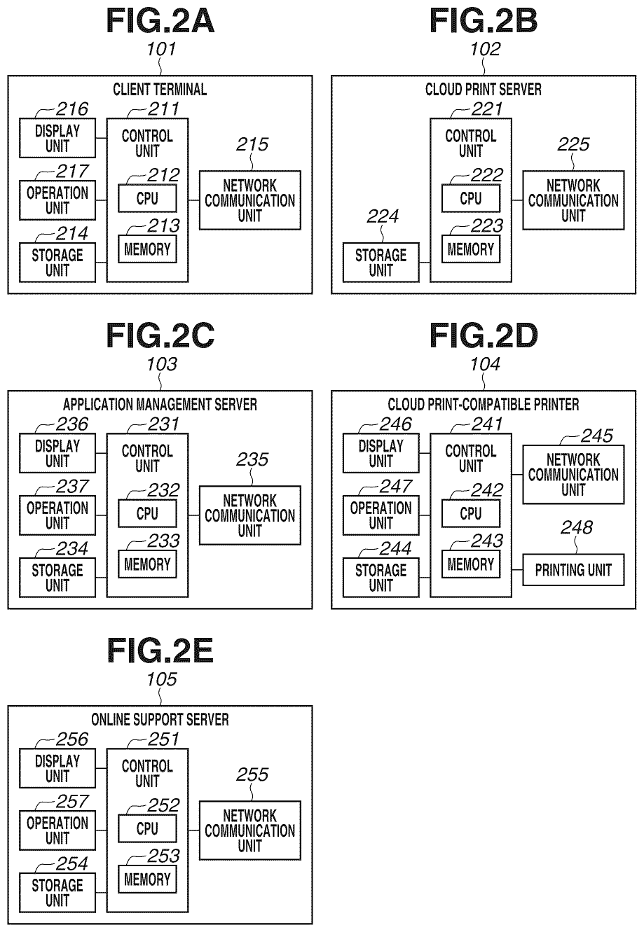

Next, a hardware configuration of the system of the present embodiment will be described with reference to FIGS. 2A to 2E.

FIG. 2A is a block diagram illustrating a hardware configuration of the client terminal 101.

The client terminal 101 includes a display unit 216, an operation unit 217, a storage unit 214, a control unit 211, and a network communication unit 215.

The storage unit 214 refers to a non-volatile storage device such as a hard disk or a solid-state disk (SSD), and is capable of storing and rewriting digital data.

The control unit 211 includes a central processing unit (CPU) 212 and a memory 213, and controls the overall operations of the client terminal 101. The CPU 212 loads a program stored in the storage unit 214 into the memory 213 and executes the program. The memory 213 is the main memory of the CPU 212 and is used as a working area and a temporary storage area for loading various programs.

The network communication unit 215 is a device that communicates via the network 107, which is external to the client terminal 101. Specifically, network communication unit 215 inputs and outputs digital data to and from external servers, client terminals, and other devices via the network 107.

The display unit 216 is a device, such as a liquid crystal display for displaying visual information to a user in real time. The operation unit 217 is a device for receiving inputs from a user via a keyboard, a mouse, and other input devices. A device having the functions of both the display unit 216 and the operation unit 217, such as a touch panel, may be used.

FIG. 2B is a block diagram illustrating a hardware configuration of the cloud print server 102. The cloud print server 102 includes a storage unit 224, a control unit 221, and a network communication unit 225.

Descriptions of the storage unit 224, the control unit 221, and the network communication unit 225 are omitted, as they are equivalent to those of the client terminal 101.

In this embodiment, the cloud print server 102 is described as being configured as a single information processing apparatus having the hardware configuration illustrated in FIG. 2B; however, the cloud print server 102 may also include a plurality of information processing apparatuses as illustrated in FIG. 2B.

FIG. 2C is a block diagram illustrating a hardware configuration of the application management server 103. The application management server 103 includes a display unit 236, an operation unit 237, a storage unit 234, a control unit 231, and a network communication unit 235.

Descriptions of the display unit 236, the operation unit 237, the storage unit 234, the control unit 231, and the network communication unit 235 are omitted, as they are equivalent to those of the client terminal 101.

In this embodiment, the application management server 103 is described as being configured as a single information processing apparatus having the hardware configuration illustrated in FIG. 2C; however, the application management server 103 may include a plurality of information processing apparatuses.

FIG. 2D is a block diagram illustrating a hardware configuration of the cloud print-compatible printer 104. The cloud print-compatible printer 104 includes a display unit 246, an operation unit 247, a storage unit 244, a control unit 241, a network communication unit 245, and a printing unit 248.

The display unit 246 is provided in the cloud print-compatible printer 104, such as a touch panel or a light emitting diode (LED), that displays information to the user in real time.

The operation unit 247 is a device for receiving inputs from a user, and may include hard keys such as a numeric keypad in addition to a touch panel. Descriptions of the storage unit 244 and the control unit 241 are omitted, as they are equivalent to those in the client terminal 101.

The network communication unit 245 is a device that communicates via the external network 107, and is mainly responsible for receiving print data and transmitting information about the status of the cloud print-compatible printer 104, such as an error state, to an external server and the like.

The printing unit 248 is a device that performs printing processes by executing a series of operations including sheet-feeding, printing, and discharge of sheets prepared in a cassette or a tray. The printing method is not particularly limited, and may be an electrophotographic method or an inkjet method. The printing unit 248 also includes finishing devices used during sheet discharge, such as a duplex unit, a stapler, and a punch unit.

In the present embodiment, a single-function printer that performs only a printing function is described as an example of the cloud print-compatible printer 104. However, a multifunction printer (multifunction peripheral) that has a scanner function and a fax function may also be used.

FIG. 2E is a hardware block diagram illustrating details of the online support server 105. In the present embodiment, the online support server 105 is described as being configured as a single information processing apparatus. However, the online support server 105 may include a plurality of information processing apparatuses.

The online support server includes a display unit 256, an operation unit 257, a storage unit 254, a control unit 251, and a network communication unit 255. Descriptions of the display unit 256 and the operation unit 257 are omitted, as they are equivalent to those of the display unit 216 and the operation unit 217 of the client terminal 101.

The storage unit 254 is a memory device such as a HDD or an SSD. The storage unit 254 stores a file including information for extending the functions provided by the client terminal 101.

The control unit 251 includes a CPU 252 and a memory 253. The CPU 252 controls the entire online support server 105. The memory 253 is used for processing executed by the CPU 252. The network communication unit 255 is an interface for the online support server 105 to communicate with the client terminal 101. The online support server 105 receives a request to acquire a file stored in the storage unit 254 via the network communication unit 255, and transmits the corresponding file to the client terminal 101.

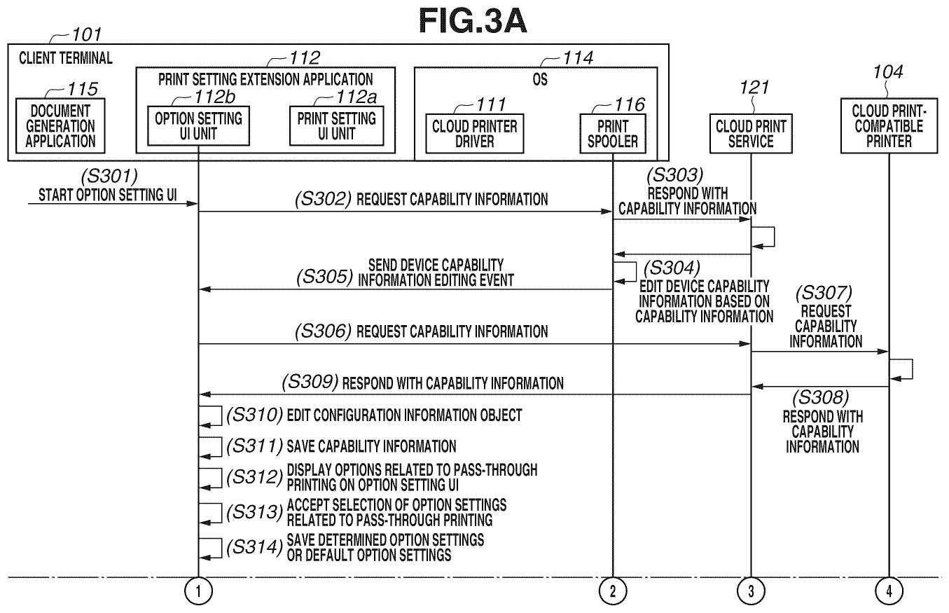

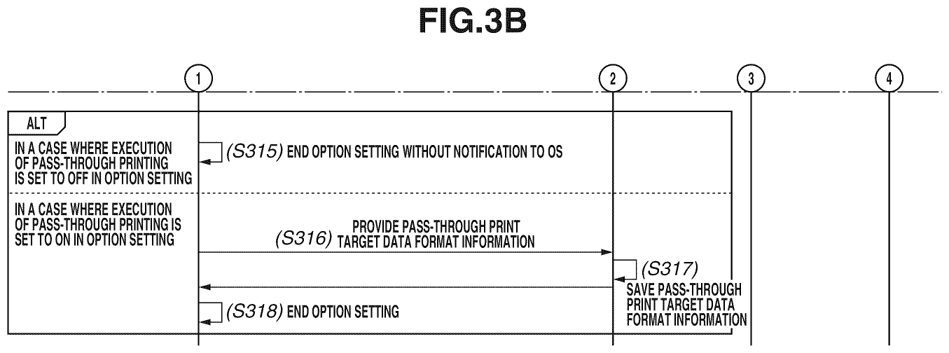

Next, an example of a user operation procedure for option settings and a sequence between each piece of software and print service in the present embodiment will be described with reference to FIGS. 3A and 3B.

FIGS. 3A and 3B illustrate a sequence between modules in a case where the user sets options via an option setting UI unit 112b of the print setting extension application 112.

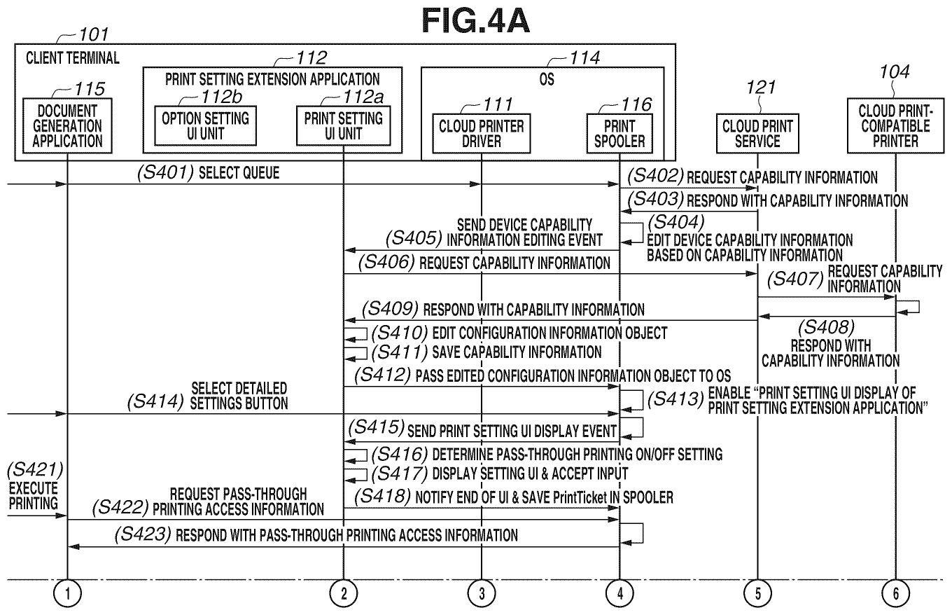

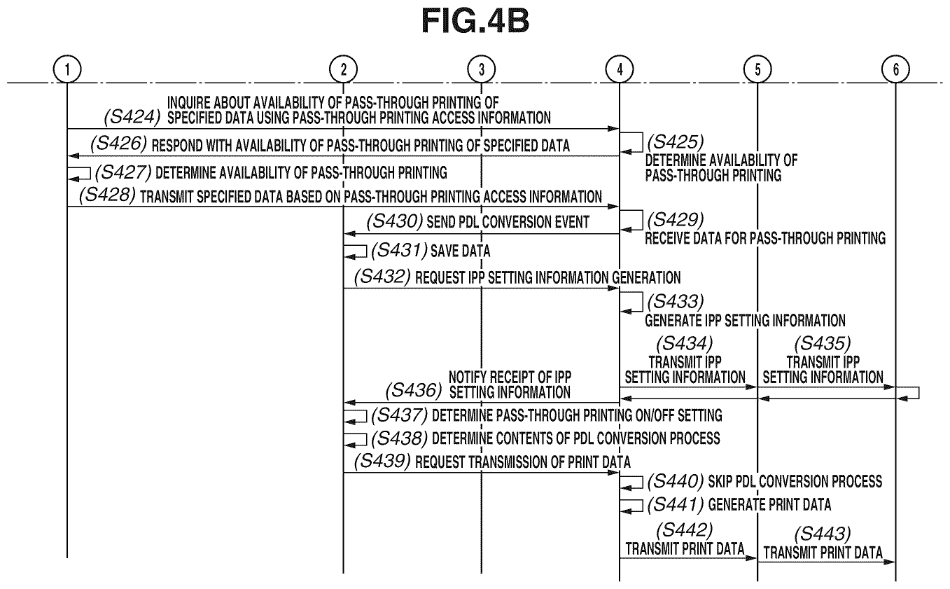

Initially, the user issues an instruction to start the print setting extension application 112 independently. For example, the print setting extension application 112 is selected from an application list, such as a start menu, and is started. Alternatively, a list of connected printers may be displayed on a setting screen of the OS, and the print setting extension application 112 corresponding to the printer may be started. The method of displaying the list of connected printers differs from the method of displaying the print setting UI of the print setting extension application 112, described below with reference to FIGS. 4A and 4B and other drawings (without passing through the print setting screen of the document generation application 115).

In step S301, the print setting extension application 112 receives an instruction to start an option setting UI, and starts the option setting UI unit 112b.

In step S302, the option setting UI unit 112b of the print setting extension application 112 requests capability information about the cloud print-compatible printer 104 from the cloud print service 121 via the print spooler 116 of the OS 114. In step S303, the cloud print service 121 responds to the OS 114 with the capability information about the cloud print-compatible printer 104. In step S304, the OS 114 adds the capability information acquired in step S303 to device capability information held by the OS 114.

In step S305, the OS 114 notifies the print setting extension application 112, via the print spooler 116, of an event in which the device capability information is editable.

In step S306, the option setting UI unit 112b of the print setting extension application 112 requests capability information about the cloud print-compatible printer 104 from the cloud print service 121. At this time, the option setting UI unit 112b selects a type(s) of capability or capabilities that does/do not overlap with the types of capabilities in the capability information requested by the OS 114.

In step S307, the cloud print service 121 issues a request for acquisition of capability information to the cloud print-compatible printer 104 using the IPP protocol. In step S308, the cloud print-compatible printer 104 responds with the requested capability information to the cloud print service 121. In step S309, the cloud print service 121 responds with the requested capability information to the option setting UI unit 112b.

In step S310, upon acquisition of printer vendor-specific capability information from the cloud print-compatible printer 104, the print setting extension application 112 edits the device capability information held by the OS 114 via the configuration information object.

In step S311, the print setting extension application 112 combines the capability information acquired by the print setting extension application 112 with the capability information acquired by the OS 114, and duplicates and stores the combined data in a data holding area of the application as the device capability information data about the print setting extension application 112.

In step S312, the option setting UI unit 112b of the print setting extension application 112 displays an option setting UI including options related to pass-through printing based on the acquired device capability information.

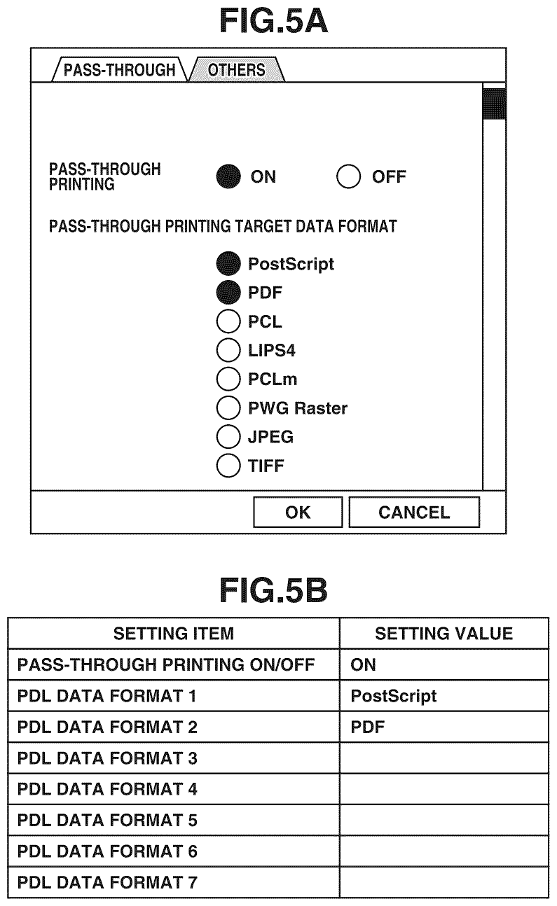

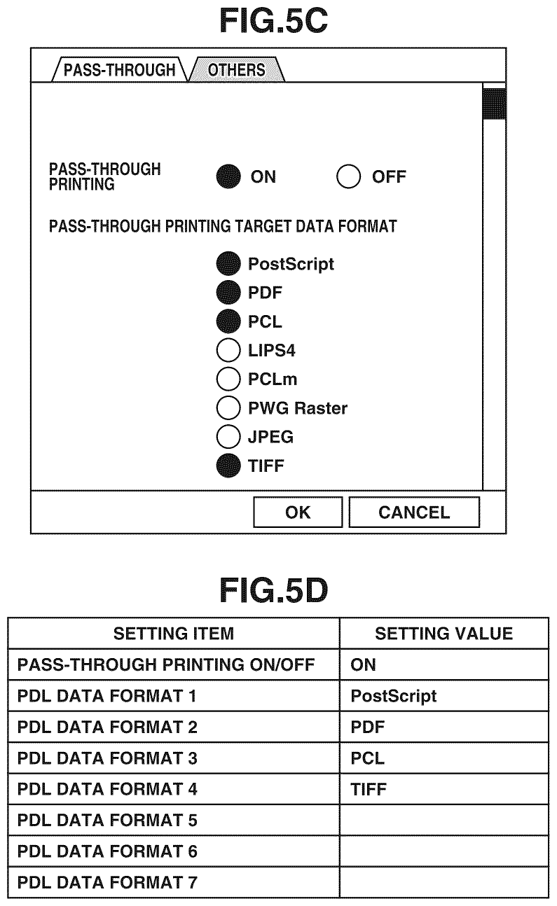

Here, FIGS. 5A and 5C each illustrate an option setting UI (an example of an option setting screen) displayed by the option setting UI unit 112b of the print setting extension application 112.

As illustrated in FIGS. 5A and 5C, the option setting UI unit 112b of the print setting extension application 112 displays, as an option setting UI, pass-through printing ON/OFF and a list of data formats for pass-through printing supported by a connected printer.

Data formats for pass-through printing in IPP printing include PostScript (PS), Portable Document Format (PDF), Printer Control Language (PCL), Printer Command Language Mobile (PCLm), LBP (Laser Beam Printer) Image Processing System level 4 (LIPS4), Printer Working Group (PWG)-Raster Format, Tagged Image File Format (TIFF), and Joint Photographic Experts Group (JPEG).

In step S313, the option setting UI unit 112b of the print setting extension application 112 receives the selection of an option setting(s) related to pass-through printing from the user.

Here, if there is no selection made by the user in receiving the option setting, in step S314, the option setting UI unit 112b stores default option settings predetermined in the print setting extension application, in the data holding area of the application.

FIG. 5A illustrates an example of default option settings. In this example, the following settings are enabled by default.
Pass-through printing: ON
Pass-through printing target data formats: PostScript and PDF

Thus, the information illustrated in FIG. 5B is stored in the data holding area of the application.

The information in FIG. 5B is a diagram schematically illustrating the data to be stored in step S314. The setting items and setting values illustrated in FIG. 5B are stored in a form that allows the stored data to be referenced. If there is a user selection in receiving option settings, the option setting UI unit 112b of the print setting extension application 112 stores the received option settings in the data holding area of the application.

FIG. 5C illustrates an example of option settings selected by the user.

In this example, the following settings are enabled by user selection:
Pass-through printing: ON
Pass-through printing target data formats: PostScript, PDF, PCL, and TIFF

Thus, the information illustrated in FIG. 5D is stored in the data holding area of the application.

The information illustrated in FIG. 5D schematically illustrates the data to be stored in step S314.

The setting items and setting values illustrated in FIG. 5D are stored in a form that allows the stored data to be referenced. The option setting UI unit 112b of the print setting extension application 112 stores the option settings. If the pass-through printing is set to enabled in the option setting selection, in step S316, information about the pass-through printing target data formats is provided to the OS 114 via the print spooler 116.

If the pass-through printing is set to OFF in the option settings, in step S315, the option setting is ended without providing the OS 114 with information about the pass-through printing target data formats.

In response to receiving the information about the pass-through printing target data formats from the print setting extension application 112, in step S317, the OS 114 stores the information about the pass-through printing target data formats, and recognizes that execution of the pass-through printing is possible.

In response to receiving a receipt notification from the OS 114, in step S318, the option setting UI unit 112b of the print setting extension application 112 ends the option setting.

Next, an example of a user operation procedure from print setting to print execution, and a sequence between each piece of software and print service in the present embodiment will be described with reference to FIGS. 4A and 4B. FIGS. 4A and 4B illustrate a sequence between modules in a case where a user selects a print queue for a printer.

In step S401, the print spooler 116 of the OS 114 receives a selection of a print queue (a printing apparatus that is a printing destination) made by the user via the document generation application 115 and the cloud printer driver 111.

In step S402, the OS 114 requests capability information of the cloud print-compatible printer 104 from the cloud print service 121 via the print spooler 116. The capability information to be requested is determined by the OS 114 based on print setting items supported by the OS itself. The OS 114 requests the capability information determined to be the request target from the cloud print service 121, using a standard IPP protocol such as Get-printer-Attributes.

In step S403, the cloud print service 121 responds to the OS 114 with the capability information of the cloud print-compatible printer 104. In step S404, the OS 114 adds the capability information acquired in step S403 to its capability information held by the OS 114 itself.

In step S405, the OS 114 notifies the print setting extension application 112 of an event in which the device capability information is editable, via the print spooler 116. In response to the notification of this event, the print setting extension application 112 can use an API of the OS that can edit the device capability information.

This event enables the print setting UI unit 112a of the print setting extension application 112 to directly acquire capability information that is not supported by the OS 114 from the cloud print service 121.

In response to receiving the device capability information editing event from the OS 114, in step S406, the print setting UI unit 112a of the print setting extension application 112 requests the capability information about the cloud print-compatible printer 104 from the cloud print service 121.

At this time, the print setting UI unit 112a of the print setting extension application 112 selects the type of capability information to be requested, based on the types of capability information held in the print setting extension application 112, and selects a type of capability information that does not overlap with the type of capability information requested by the OS 114.

The print setting UI unit 112a of the print setting extension application 112 inquires of the cloud print service 121 about the capability information selected as the request target, using a standard IPP protocol, such as Get-printer-Attributes. In this manner, the print setting extension application 112 can also acquire capability information not supported by the OS 114.

In step S407, in response to receiving the request for capability information, the cloud print service 121 requests the cloud print-compatible printer 104 to provide capability information using the IPP protocol. In step S408, the cloud print-compatible printer 104 responds with the requested capability information to the cloud print service 121. In step S409, the cloud print service 121 responds with the requested capability information to the print setting UI unit 112a of the print setting extension application 112 (S409).

In response to obtaining the printer vendor-specific capability information from the cloud print-compatible printer 104, in step S410, the print setting UI unit 112a of the print setting extension application 112 edits the device capability information held by the OS 114 via a configuration information object. The configuration information object is a collection of data groups to be used to edit the device capability information. Since the print setting UI unit 112a of the print setting extension application 112 cannot directly edit the device capability information held by the OS 114, the print setting UI unit 112a uses the configuration information object to alter the device capability information held by the OS 114.

In step S411, the print setting UI unit 112a of the print setting extension application 112 duplicates and stores the capability information acquired by the print setting UI unit 112a and the capability information acquired by the OS 114 in the data holding area of the application, as its device capability information data about the print setting UI unit 112a.

In step S412, the print setting UI unit 112a of the print setting extension application 112 passes the edited configuration information object to the OS 114. In response to receiving the configuration information object from the print setting UI unit 112a of the print setting extension application 112, the OS 114 merges the device capability information held by the OS itself with the device capability information that has been added to the configuration information object, thus updating the device capability information held by the OS 114 as new device capability information.

In response to generating the new device capability information, the OS 114 enables the print queue. As a result, in step S413, in response to receiving a selection of a detailed settings button made by the user via the document generation application 115, issuance of an event that causes the print setting extension application 112 to display the print setting UI is enabled.

In response to receiving a selection of the detailed settings button made by the user via the document generation application 115, in step S414, the OS 114 notifies the print setting extension application 112 of an event that enables the display of the print setting UI. The selection of the detailed settings button by the user is an example of an instruction to display a print setting screen.

In step S415, the print setting UI unit 112a of the print setting extension application 112 receives a print setting UI display event from the OS 114. At this time, the print setting UI unit 112a receives, from the print spooler 116, PrintCapabilities based on the device capability information and a PrintTicket indicating the current print settings.

In step S416, the print setting extension application 112 reads option information related to pass-through printing (e.g., FIGS. 5B and 5D) from the option setting information stored in step S314, and determines whether pass-through printing is set to ON or OFF.

In step S417, the print setting UI unit 112a of the print setting extension application displays the print setting UI based on the PrintCapabilities and the PrintTicket. The PrintTicket is a file indicating print setting information described in XML format.

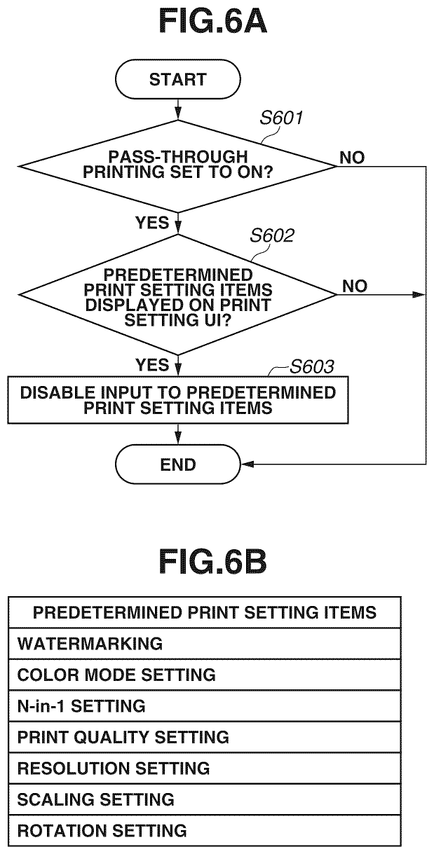

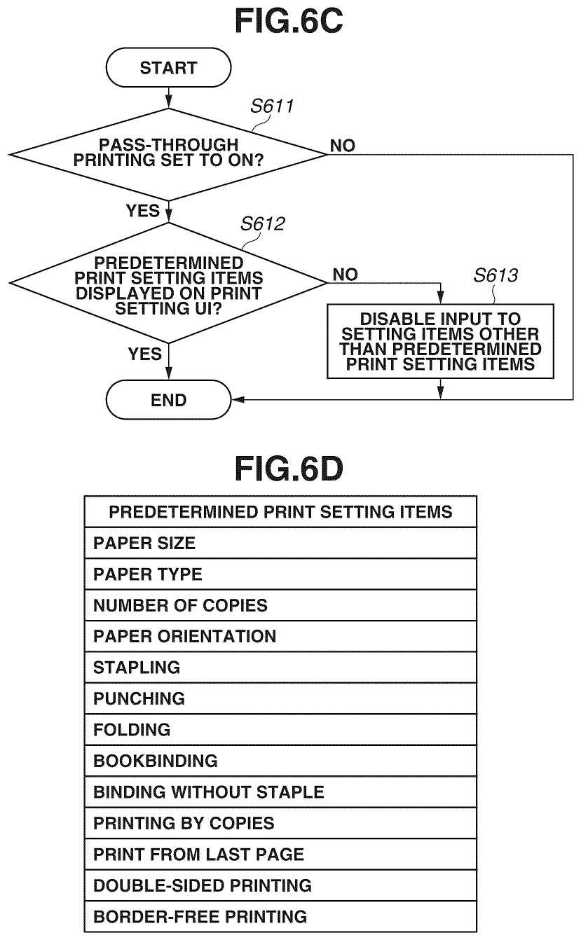

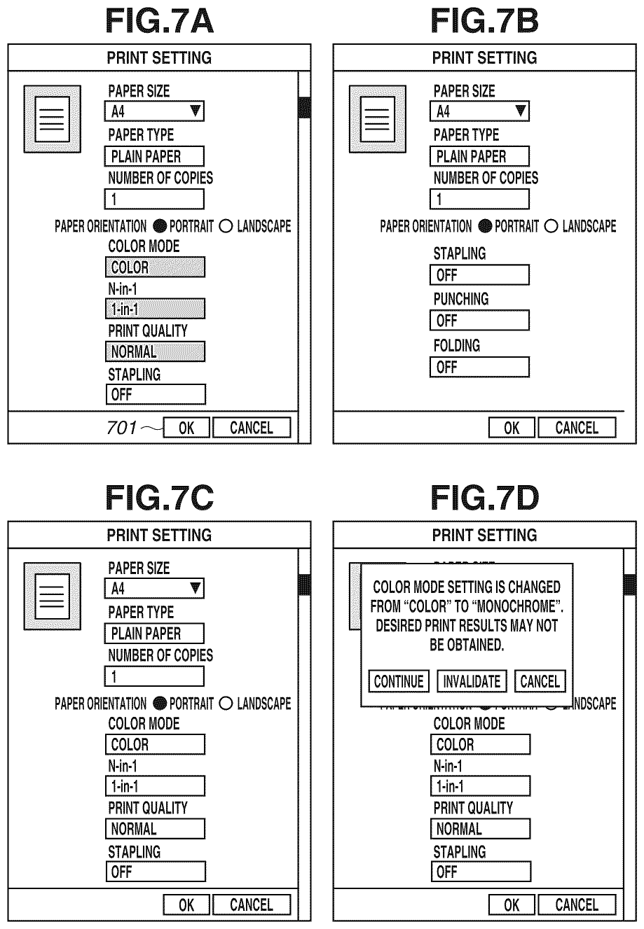

Here, if it is determined that the pass-through printing execution is set to ON, the print setting UI unit 112a disables the predetermined print settings. FIGS. 6A to 6D and 7 illustrate details of the process in a case where the pass-through printing is determined to be ON.

FIGS. 6A and 6C illustrate an example of details of processing to be performed by the print setting UI unit 112a in a case where pass-through printing is determined to be set to ON. FIG. 6B illustrates an example of print setting items that are predetermined by the printer vendor as setting items that cannot be set by the user at the time of execution of pass-through printing. In contrast, FIG. 6D illustrates an example of print setting items that are predetermined by the printer vendor as setting items that can be set by the user at the time of execution of pass-through printing.

The data on the print setting items illustrated in FIGS. 6B and 6D may be stored in the print setting extension application 112, or may be stored in the online support server 105, the application management server 103, the cloud print server 102, or other devices. Alternatively, the cloud print-compatible printer 104 may store the data.

FIGS. 7A and 7B illustrate examples of a UI that disables the reception of user input for setting items of the functions that involve image processing and/or print layout change for print image data. Initially, an example of predetermining setting items for which print settings are not received at the time of pass-through printing will be described with reference to FIGS. 6A, 6B, and 7A.

In step S601, the print setting extension application 112 reads the option setting value information related to pass-through printing stored in step S314 (e.g., FIGS. 5B and 5D), and determines whether to perform pass-through printing based on the setting value of “Pass-through printing ON/OFF”. If the setting value of “Pass-through printing ON/OFF” is set to ON (YES in step S601), the print setting extension application 112 determines that pass-through printing is to be performed.

If the setting value of “Pass-through printing ON/OFF” is set to ON, a UI (not illustrated) may be displayed to receive the user's selection of whether to perform pass-through printing. Although this increases the number of operations to be performed by the user, it is effective in a case where whether to perform pass-through printing or to use various print settings differs depending on the content of the data to be printed and the purpose of printing.

In step S602, the print setting extension application 112 determines whether any of the predetermined print setting items (FIG. 6B) is present among the setting items displayed on the print setting UI based on the capability information stored in step S411.

In step S602, if it is determined that a predetermined print setting item(s) is/are present among the print setting items displayed in the print setting UI (an example of a print setting screen) illustrated in FIG. 7A (YES in step S602), the processing proceeds to step S603. In step S603, the print setting extension application disables the reception of a user input for the predetermined print setting items.

FIG. 7A illustrates a UI in which some of the predetermined print setting items are grayed out, as an example of a display form that does not allow the user to change settings. In this example, items such as color mode, N-in-1 setting, a print quality setting are grayed out.

FIG. 7B illustrates an example in which some of the predetermined print setting items are not displayed in order to disable the reception of a user input. In this example, color mode, N-in-1 setting, and print quality setting are not displayed. In FIGS. 6A and 6B, setting items for which print settings are not accepted at the time of pass-through printing are predefined. In contrast, setting items for which print settings are accepted may be predefined even at the time of pass-through printing, and the reception of print settings for the other setting items may be rejected.

FIGS. 6C and 6D illustrate an example of details of processing in a case where the setting items for which print settings are accepted even at the time of pass-through printing are determined in advance and print settings are not accepted for the other setting items.

In step S611, the print setting extension application 112 reads the option setting value information related to pass-through printing stored in step S314 (e.g., FIGS. 5B and 5D), and determines whether to perform pass-through printing based on the setting value of “Pass-through printing ON/OFF”. If the setting value of “Pass-through printing ON/OFF” is set to ON (YES in step S611), the print setting extension application 112 determines that pass-through printing is to be performed.

In step S612, the print setting extension application 112 determines whether the setting items to be displayed on the print setting UI correspond to the predetermined print setting items (FIG. 6D) based on the capability information stored in step S411.

In step S612, if the print setting extension application 112 determines that there is any print setting item displayed in the print setting UI that does not correspond to the predetermined print setting items, the processing proceeds to step S613. In step S613, the print setting extension application 112 disables the acceptance of a user input for the setting item.

Returning to the description of FIGS. 4A and 4B. In step S417, the user presses an “OK” button (701 in FIG. 7A) in the print setting UI of the print setting extension application 112 to close the print setting UI and complete the print setting operation. At this time, the print setting UI unit 112a writes the setting values set via the print setting UI into the PrintTicket. As a result of closing the print setting UI unit, the screen for user operation returns to the print setting screen provided by the document generation application 115.

In step S418, the print setting extension application 112 transmits a UI end notification together with the PrintTicket to the print spooler 116 of the OS 114, and completes the processing involving the print setting screen of the print setting extension application 112.

In step S421, the document generation application 115 receives a print execution instruction from the user on the print setting screen provided by the document generation application 115. In step S422, the document generation application 115 requests access information for pass-through printing from the print spooler 116 of the OS 114. The access information for pass-through printing is used as information for inquiring of the print spooler 116 of the OS 114 about pass-through printing availability, and for transmitting data for pass-through printing to the print spooler 116 of the OS 114.

In step S423, the print spooler 116 of the OS 114 responds with the access information for pass-through printing to the document generation application 115 (S423).

In step S424, in response to obtaining the access information for pass-through printing, the document generation application 115 specifies the PDL data format and inquires of the print spooler 116 of the OS 114 about pass-through printing availability. In step S425, the print spooler 116 of the OS 114 determines pass-through printing availability based on the pass-through printing target data formats that have been received from the print setting extension application 112 and stored in step S316.

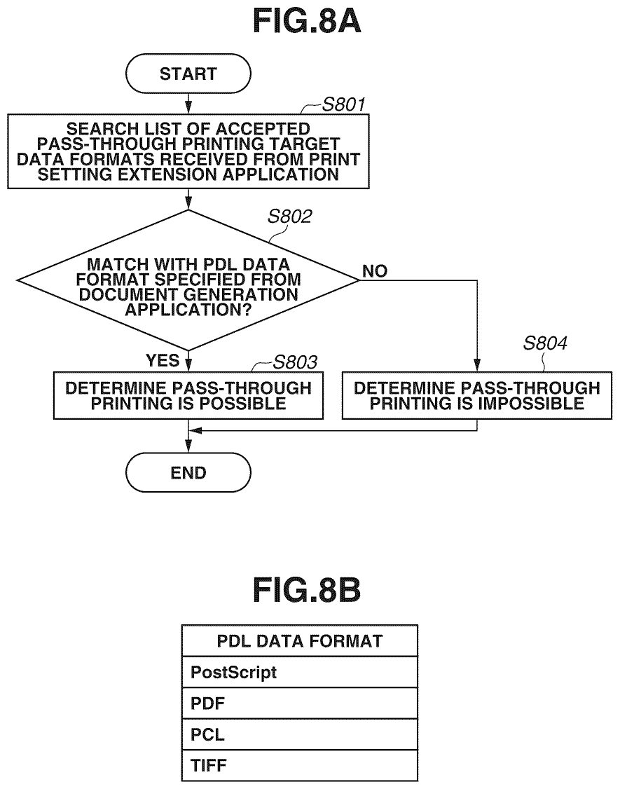

FIGS. 8A and 8B illustrate the details of pass-through printing availability determination. FIG. 8A illustrates an example of the details of a pass-through printing availability determination process. FIG. 8B illustrates an example of a list of pass-through printing target data formats received from the print setting extension application 112.

In step S801, the print spooler 116 of the OS 114 searches the list of pass-through print target data formats received from the print setting extension application 112 for the specified PDL data format received from the document generation application 115.

In step S802, the print spooler 116 of the OS 114 compares the specified PDL data format received from the document generation application 115 with each data format in the list of pass-through printing data formats received from the print setting extension application 112, and determines whether there is a match.

In step S802, if the print spooler 116 determines that the specified PDL data format received from the document generation application 115 is included in the list of pass-through printing data formats received from the print setting extension application 112 (YES in step S802), the processing proceeds to step S803. In step S803, the print spooler 116 determines that pass-through printing is available.

In step S802, if the print spooler 116 determines that the specified PDL data format received from the document generation application 115 is not included in the list of pass-through printing target data formats received from the print setting extension application 112 (NO in step S802), the processing proceeds to step S804. In step S804, the print spooler 116 determines that pass-through printing is unavailable.

Returning to the description of FIGS. 4A and 4B, in step S426, the print spooler 116 of the OS 114 responds to the document generation application 115 with a result of the pass-through printing availability determination.

In step S427, the document generation application 115 determines whether to continue pass-through printing based on the result of the pass-through printing availability determination obtained from the print spooler 116 of the OS 114. If the document generation application 115 determines in step S427 that pass-through printing is to be continued, the document generation application 115 transmits data in the data format specified in step S424 to the print spooler 116 of the OS 114, based on the access information for pass-through printing.

In step S429, the print spooler 116 of the OS 114 treats, as the data for pass-through printing, the received data based on the access information for pass-through printing. In response to receiving the data for pass-through printing, in step S430, the print spooler 116 of the OS 114 notifies the print setting extension application 112 of a PDL conversion event. The PDL conversion event indicates a process of converting intermediate image data into PDL that can be processed by the printer.

At this time, in a case where the printing is not pass-through printing, the print setting extension application 112 receives, from the print spooler 116 of the OS 114, the notification of the event along with the intermediate image data and the PrintTicket in which the print setting values set using the print setting UI unit 112a are recorded. In contrast, in the case of pass-through printing, since no intermediate image data is generated, the print setting extension application 112 receives only a PrintTicket in which the print setting values set in the print setting UI unit 112a are recorded, together with the event notification from the print spooler 116 of the OS 114.

In step S431, the print setting extension application 112 stores the PrintTicket in the data holding area of the application.

In step S432, the print setting extension application 112 uses the API of the OS 114 to request the print spooler 116 of the OS 114 to generate IPP print setting information. The IPP print setting information refers to print setting information defined by a combination of IPP attributes and IPP attribute values. In step S433, in response to the request, the print spooler of the OS 114 generates the IPP print setting information. Here, the print spooler of the OS generates the IPP print setting information based on the PrintTicket.

In step S434, the print spooler of the OS 114 transmits the IPP print setting information to the cloud print service 121. In step S435, the cloud print service 121 transmits the IPP print setting information to the cloud print-compatible printer 104. In step S436, the cloud print-compatible printer 104 notifies the print setting extension application 112 of the reception of the IPP print setting information via the cloud print service 121 and the print spooler 116 of the OS 114.

In step S437, the print setting extension application 112 reads the option setting value information related to pass-through printing stored in step S314 (e.g., FIGS. 5B and 5D), and determines whether to perform pass-through printing based on the setting value of “Pass-through printing ON/OFF”. If the setting value of “Pass-through printing ON/OFF” is set to ON, the print setting extension application 112 determines that pass-through printing is to be performed.

In step S438, the print setting extension application 112 determines the details of PDL conversion based on the determination as to whether pass-through printing is to be performed.

Specifically, if it is determined in S437 that pass-through printing is to be performed, PDL conversion based on the intermediate image data is unnecessary, so that the print setting extension application 112 determines that the PDL conversion process is to be skipped. If it is determined in S437 that pass-through printing is not to be performed, the print setting extension application 112 determines that PDL conversion process is to be executed on the intermediate image data received from the print spooler 116 of the OS 114.

In step S439, the print setting extension application 112 requests the print spooler 116 of the OS 114 to transmit print data to the cloud print-compatible printer 104.

If no PDL conversion processing is requested, in step S440, the print spooler 116 of the OS 114 generates print data to be transmitted to the printer using the IPP protocol, based on the PDL received from the document generation application 115. If a PDL conversion processing is requested, the print spooler 116 of the OS 114 generates print data to be transmitted to the printer using the IPP protocol based on the converted PDL.

In step S442, the print spooler 116 of the OS 114 transmits the print data including the final PDL to the cloud print service 121 via the print queue. In step S443, the cloud print service 121 transmits the print data transmitted from the print spooler 116 of the OS 114 to the cloud print-compatible printer 104.

Although cloud printing is used as an example in this process, similar processing can also be applied to local printing that does not involve a server. In such cases, the processing described as being performed by the cloud print service 121 is also performed by the cloud print-compatible printer 104.

As described above, according to the present embodiment, the print setting extension application 112 allows the user to select the pass-through target data format, thus enabling the user to recognize the data formats supported by the printer. This enables output of appropriate data for pass-through printing. As a result, errors caused by the printer receiving data in an unexpected format and failing to print can be prevented.

### Second Embodiment

In the first embodiment, examples have been described in which, during pass-through printing, changes to predetermined print settings are disabled, or only predetermined print settings are enabled and the other print settings are hidden. In the present embodiment, an example will be described in which, during pass-through printing, a warning and options are displayed for changes made to predetermined print settings.

Specific processing according to the present embodiment will be described with reference to FIGS. 4A, 4B, 9, 7C, and 7D. Only the differences from the first embodiment will be described in the present embodiment. A system configuration and hardware configuration of the present embodiment are similar to those of the first embodiment except for some parts, so descriptions thereof will be omitted.

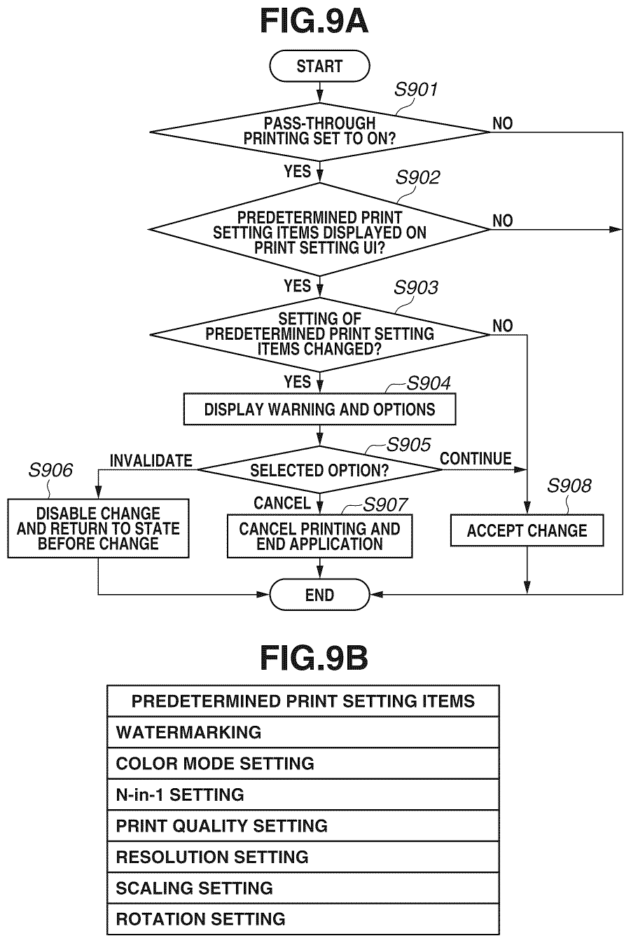

As a difference from the first embodiment, an example of processing to be performed by a print UI will be described below with reference to FIGS. 4A, 4B, 9A, and 9B. The main processing sequence in the present embodiment from steps S401 to S416 is similar to that in the first embodiment, so descriptions thereof will be omitted.

After receiving a print setting UI display event and determining whether the execution of pass-through printing is ON or OFF, in step S417, a print setting UI unit 112a of a print setting extension application 112 displays a print setting UI and receives a user input. The print setting UI unit 112a of the print setting extension application 112 displays the print setting UI based on PrintCapabilities and a PrintTicket. The PrintTicket is a file indicating print setting information described in XML format.

In step S417, the print setting UI unit 112a of the print setting extension application 112 receives a print setting input from the user. When the input is received, the print setting UI unit 112a determines whether any of the print setting items corresponding to the predetermined print setting items has been changed. If the print setting UI unit 112a determines that any of the print setting items corresponding to the predetermined print setting items has been changed, a warning is displayed.

FIGS. 9A, 9B, and 7 illustrate details of a process for displaying a warning.

FIGS. 9A and 9B illustrate an example of detailed processing for displaying, during pass-through printing, a warning and options for a change to a predetermined print setting(s). FIGS. 7C and 7D illustrate an example of a UI in a case where a warning and options are displayed for a change to a predetermined print setting(s).

Initially, in step S901, the print setting extension application 112 reads option setting value information related to pass-through printing stored in step S314 (e.g., FIGS. 5B and 5D), and determines whether to perform pass-through printing based on the setting value of “Pass-through printing ON/OFF”. If it is determined that the setting value of “Pass-through printing ON/OFF” is set to ON (YES in step S901), the print setting extension application 112 determines that pass-through printing is to be performed.

In step S902, the print setting extension application 112 determines whether any of the print setting items to be displayed on the print setting UI corresponds to the predetermined print setting items (FIG. 9B), based on the ability information saved in step S411.

In step S902, if any of the print setting items to be displayed on the print setting UI (FIG. 7C) corresponds to the predetermined print setting items (YES in step S902), the processing proceeds to step S903. In step S903, the print setting extension application 112 detects whether any setting change has been made through a user input to the print settings of the setting items corresponding to the predetermined print setting items.

In step S903, if the print setting UI unit 112a of the print setting extension application 112 detects any setting change, made through the user input, to the print setting items corresponding to the predetermined print setting items in S903 (YES in step S903), the processing proceeds to step S904. In step S904, the print setting UI unit 112a displays a warning and options.

Referring to FIG. 7C, the color mode setting based on the PrintTicket is “color”, but FIG. 7D illustrates an example in which the color mode has been changed to “monochrome” through a user input. The color mode corresponds to a predetermined print setting item in the list in FIG. 9B. Thus, the print setting extension application 112 detects the change, and the print setting UI unit 112a displays a warning and options as illustrated in FIG. 7D.

In step S905, if the user selects “Continue” from the options (FIG. 7D) (“CONTINUE”, in step S905), the processing proceeds to step S908. In step S908, the print setting extension application 112 accepts the change made to the print setting. Specifically, in step S908, the print setting extension application 112 accepts the change from “Color” to “Monochrome”.

In step S905, if the user selects “Invalidate” (FIG. 7D) from the options (“INVALIDATE”, in Step S905), the processing proceeds to step S906. In step S906, the print setting extension application 112 invalidates the setting change made through the user input, and the print setting UI unit 112a returns the changed print setting to the setting before the change. Specifically, the print setting UI unit 112a returns the print setting that has been once changed to “monochrome” to “color” that is the setting before the change.

In step S905, if the user selects “Cancel” from the options (FIG. 7D) (“CANCEL”, in step S905), the processing proceeds to step S907. In step S907, the print setting extension application 112 cancels the printing, and terminates the print setting extension application 112.

Returning to the description of FIGS. 4A and 4B, in step S417, the user presses an “OK” button (701 in FIG. 7A) in the print setting UI of the print setting extension application 112 to close the print setting UI and complete the print setting operation. At this time, the print setting UI unit 112a writes the setting values set via the UI into the PrintTicket. As a result of the print setting UI unit 112a closing the print setting UI, the user operation screen returns to the print setting screen provided by the document generation application 115.

In step S418, the print setting extension application 112 transmits a UI end notification together with the PrintTicket to the print spooler 116 of an OS 114, and completes the processing involving the print setting screen.

The operations from receiving an input for execution of printing (step S421) to transmitting print data (step S443) are similar to those in the first embodiment, so that the descriptions thereof are omitted. Although cloud printing is used as an example in this process, similar processing can also be applied to local printing.

As described above, according to the present embodiment, presenting a warning and options to a user allows them to obtain a printed result that more closely matches the user's intention.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-155158, filed Sep. 9, 2024, which is hereby incorporated by reference herein in its entirety.

What is claimed is:

1. A non-transitory computer-readable storage medium storing an application program including executable instructions, which when executed by one or more processors of an information processing apparatus including an Internet Printing Protocol (IPP) Class Driver and the application program cooperating with the IPP Class Driver, cause the information processing apparatus to perform a control method comprising:
receiving, from a user, a selection of a data format to be output to a printing apparatus without data format conversion; and
performing control such that, in receiving from the user a specification of a setting value for printing data in the selected data format, a specification of a setting value that is inexecutable in a case of performing the process is not accepted.

2. The non-transitory computer-readable storage medium according to claim 1, wherein an option for the data format in which the process is caused to be performed is acquired from the printing apparatus that is a printing destination.

3. The non-transitory computer-readable storage medium according to claim 1, wherein the selection of the data format in which the process is caused to be performed is received via an option setting screen that is displayable in a case where the application program is started independently.

4. The non-transitory computer-readable storage medium according to claim 1, wherein the specification of the setting value for printing the data in the selected data format is received via a print setting screen that is displayed in response to receiving a display instruction from the user in a state where data to be printed and the printing apparatus that is a printing destination are specified.

5. The non-transitory computer-readable storage medium according to claim 4, wherein the control method further comprises, displaying, in performing the process, a predetermined print setting item that is not allowed to be changed when the process is performed, on the print setting screen in a manner that a change to the predetermined print setting item is unchangeable by the user.

6. The non-transitory computer-readable storage medium according to claim 4, wherein the control method further comprises, displaying, in performing the process, a warning on the print setting screen when a change, made by the user, to the predetermined print setting item that is not allowed to be changed when the process is performed is received.

7. The non-transitory computer-readable storage medium according to claim 1, wherein the control method further comprises:
notifying the selected data format to printing software including the IPP Class Driver; and
skipping data conversion in the printing software.

8. The non-transitory computer-readable storage medium according to claim 1, wherein the process is pass-through printing.

9. A control method for an information processing apparatus including an Internet Printing Protocol (IPP) Class Driver and an application program that cooperates with the IPP Class Driver, the control method comprising:
receiving, from a user, a selection of a data format to be output to a printing apparatus without data format conversion; and
performing control such that, in receiving from the user a specification of a setting value for printing data in the selected data format, a specification of a setting value that is inexecutable in a case of performing the process is not accepted.

10. The control method according to claim 9, wherein an option for the data format in which the process is caused to be performed is acquired from the printing apparatus that is a printing destination.

11. The control method according to claim 9, wherein the selection of the data format in which the process is caused to be performed is received via an option setting screen that is displayable in a case where the application program is started independently.

12. The control method according to claim 9, wherein the specification of the setting value for printing the data in the selected data format is received via a print setting screen that is displayed in response to receiving a display instruction from the user in a state where data to be printed and the printing apparatus that is a printing destination are specified.

13. The control method according to claim 12, further comprising, displaying, in performing the process, a predetermined print setting item that is not allowed to be changed when the process is performed, on the print setting screen in a manner that a change to the predetermined print setting item is unchangeable by the user.

14. The control method according to claim 12, further comprising, displaying, in performing the process, a warning on the print setting screen when a change, made by the user, to a predetermined print setting item that is not allowed to be changed when the process is performed is received.

15. The control method according to claim 9, further comprising:
notifying the selected data format to printing software including the IPP Class Driver; and
skipping data conversion in the printing software.

16. The control method according to claim 9, wherein the process is pass-through printing.

17. An information processing apparatus having an Internet Printing Protocol (IPP) Class Driver and an application program that cooperates with the IPP Class Driver, the information processing apparatus comprising:
one or more processors; and
at least one memory storing executable instructions, which when executed by the one or more processors, cause the information processing apparatus to perform:
receiving, from a user, a selection of a data format to be output to a printing apparatus without data format conversion; and
performing control such that, in receiving from the user a specification of a setting value for printing data in the selected data format, a specification of a setting value that is inexecutable in a case of performing the process is not accepted.
